(19) United States
(12) Patent Application Publication
(10) Pub. No.: US 2020/0102179 A1
(43) Pub. Date: Apr. 2, 2020

(54) Image Forming Apparatus

(71) Applicant: Brother Kogyo Kabushiki Kaisha, Nagoya-shi (JP)

(72) Inventors: Tony Lee, Nagoya-shi (JP); Takatsugu Yamada, Nagoya-shi (JP)

(21) Appl. No.: 16/578,936

(22) Filed: Sep. 23, 2019

(30) Foreign Application Priority Data
Sep. 28, 2018 (JP) 2018-185279

(51) Int. Cl. B65H 43/00; B65H 7/06; B65H 11/00; G06F 3/12

(52) U.S. Cl. CPC B65H 43/00; B65H 7/06; B65H 11/00; B65H 2601/11; B65H 2402/45; B65H 2405/115; G06F 3/1234

(57) ABSTRACT

There is provided an image forming apparatus including a casing, a feeder unit, an image recording unit, a conveyance mechanism, an installation/removal sensor, and a controller. The controller carries out the process of: interrupting an image recording of the image recording unit if there is no recording medium supported by trays, restarting the image recording of the image recording unit by feeding the medium from a second tray after a first predetermined time has elapsed since such a time when the second tray is detected as the earliest one being removed and reinstalled, and restarting the image recording of the image recording unit by feeding the medium from a first tray if the first tray is detected as the earliest one but the second tray is not detected as being removed within a second predetermined time being longer than the first predetermined time.

### CROSS REFERENCE TO RELATED APPLICATION

The present application claims priority from Japanese Patent Application No. 2018-185279 filed on Sep. 28, 2018, the disclosures of which is incorporated herein by reference in its entirety.

### BACKGROUND

### Field of the Invention

The present disclosure relates to an image forming apparatus including at least two trays removable from a casing.

### Description of the Related Art

Conventionally, there is disclosed an image forming apparatus including two removable feed trays, a cassette installation sensor for detecting the installed feed trays, and an image forming unit for forming images on recording paper fed from the feed trays. In this image forming apparatus, the feed tray (the second tray) near the image forming unit between the two feed trays defines part of a conveyance path between the image forming unit and the feed tray (the first tray) farther from the image forming unit.

If a paper jam arises in the conveyance path of the image forming apparatus, it is necessary for a user to remove the feed tray(s) from the apparatus body for handling the jam and excluding the paper. In the publicly known image forming apparatus, when an image formation process is interrupted due to the jam, if the cassette installation sensor detects the removal and reinstallation of the feed tray(s), then it is determined that the handling of the jam is finished, and the jam is resolved. That is, it is possible to restart the image formation process without needing a user's restart instruction through keyboard input or the like.

### SUMMARY

In the image forming apparatus including such a part defined by the second tray as from the first tray to the image formation part in the conveyance path, if the above publicly known technique is applied to the case where a feed tray is empty of the recording paper, the present inventors have found out such problems as follows. That is, if a sheet of recording paper of a predetermined size (A4, for example) is set for being automatically fed from any feed tray, then the user is informed of being empty of the recording paper at the time when printing is interrupted after all feed trays are empty of the recording paper of the predetermined size loaded there. On this occasion, the user may reload the other feed tray with the recording paper after reloading one feed tray empty of the recording paper. If the removal and reinstallation of the first tray are detected, then it may have been set to restart the image formation process due to the detections. If the user removes the second tray, attempting to reload the recording paper into the second tray immediately after reloading the recording paper into the first tray, then a jam may arise later with the recording paper fed from the first feed tray. It is possible for a similar case to occur when only one feed tray is empty of the recording paper, and if the user reloads the other feed tray with the recording paper after reloading that feed tray empty of the recording paper.

An object of the present disclosure is to provide an image forming apparatus capable of restarting image recording automatically after the image recording is interrupted while preventing any jam from arising from a feed tray being empty of recording paper in the image forming apparatus where part of a conveyance path is defined by at least one feed tray.

According to an aspect of the present disclosure, there is provided an image forming apparatus including: a casing; a feeder unit including a plurality of trays having a first tray and a second tray, each of the trays being installable into and removable from the casing, each of the trays having a support surface configured to support a medium; an image recording unit arranged in the casing and configured to record an image on the medium supplied from the feeder unit based on a recording command including designation of at least one tray among the plurality of trays; a conveyance mechanism defining a conveyance path of the medium supported by each of the trays, such that a part of the conveyance path from the first tray to the image recording unit includes a portion defined by the second tray; an installation/removal sensor configured to detect whether the trays are removed from the casing or installed in the casing; and a controller. The controller is configured to perform: interrupting an image recording of the image recording unit in a case that the medium is not supported on the at least one tray designated by the recording command; restarting the image recording of the image recording unit by feeding the medium from the second tray after a first predetermined time has elapsed since such a time when the installation/removal sensor detects that the second tray is removed or reinstalled earliest in the at least one tray designated by the recording command, after the image recording is interrupted; and restarting the image recording of the image recording unit by feeding the medium from the first tray in a case that the installation/removal sensor detects that the first tray is removed or reinstalled earliest in the at least one tray designated by the recording command but does not detect that the second tray is removed within a second predetermined time being longer than the first predetermined time, after the image recording is interrupted.

According to the image forming apparatus of the present disclosure, when the interruption process is carried out, no special work is necessary for restarting the image recording; it is possible to automatically restart the image recording based on the detection of removing and reinstalling the first or second tray. Further, after reloading the first tray with the recording medium, a user may possibly reload the recording medium successively into the second tray defining part of the conveyance path from the first tray to the image recording unit. Therefore, a predetermined time before restarting the image recording is set longer than that for the case where the second tray is first detected as removed from and reinstalled into the casing, such that if the first tray is first detected as removed from and reinstalled into the casing, then the image recording will not be restarted during the period of a high possibility for the user to successively remove and reinstall the second tray. Therefore, it is possible to prevent a jam from arising from the removal of the second tray from the casing after the image recording is restarted.

### BRIEF DESCRIPTION OF THE DRAWINGS

FIG. 1 is a schematic side view showing an internal structure of a printer device of a multifunction apparatus according to an embodiment of the present disclosure;

FIG. 2 is a block diagram schematically showing an electrical configuration of the multifunction apparatus depicted in FIG. 1;

FIGS. 3A, 3B, 3C are the first half of a flow chart depicting an example of processing procedure in a controller of the multifunction apparatus depicted in FIG. 1;

FIG. 4 is the last half of the flow chart showing the example of processing procedure in the controller of the multifunction apparatus depicted in FIG. 1;

FIG. 5 is a flow chart showing an example of processing procedure of a notification process depicted in FIG. 3;

FIGS. 6A, 6B, 6C depict a flow chart depicting an example of processing procedure of a first standby time setting process depicted in FIG. 3;

FIG. 7 is a flow chart showing an example of processing procedure of a second standby time setting process depicted in FIG. 3;

FIG. 8 is a flow chart showing a modified example of the processing procedure depicted in FIGS. 3A-3C and 4; and

FIG. 9 is a flow chart showing an example of processing procedure of a third standby time setting process depicted in FIG. 8.

### DESCRIPTION OF THE EMBODIMENT

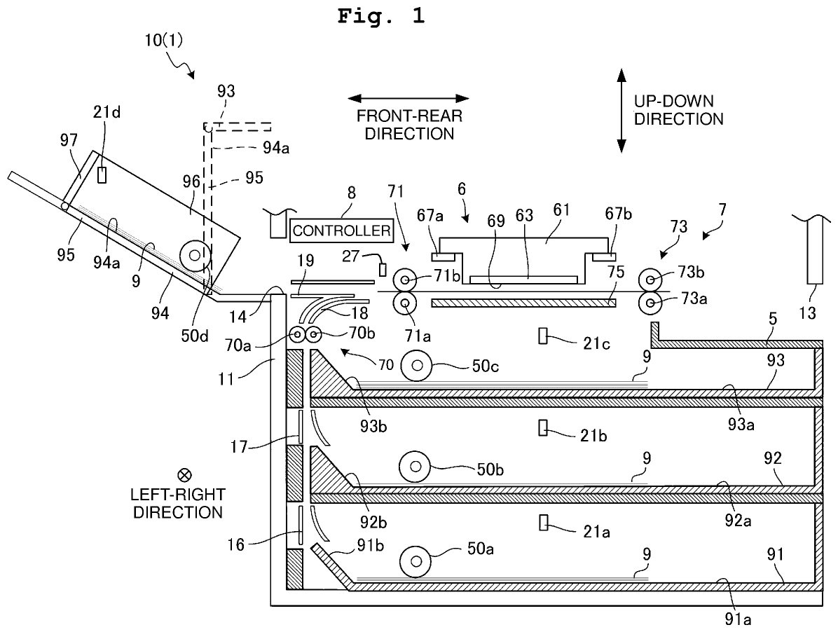

Hereinbelow, referring to the accompanied drawings, an embodiment of the present disclosure will be explained. With respect to this embodiment, such a so-called multifunction apparatus 1 will be explained as provided with a printing function, a scanning function, and a photocopy function. In the following explanation, based on the multifunction apparatus 1 being placed in a usable condition (condition of FIG. 1), an up/down direction is defined; with an opening 13 of a casing 11 being provided at the near side (front side), a front/rear direction is defined; and with the multifunction apparatus 1 being viewed from the near side (front side), a left-right direction is defined.

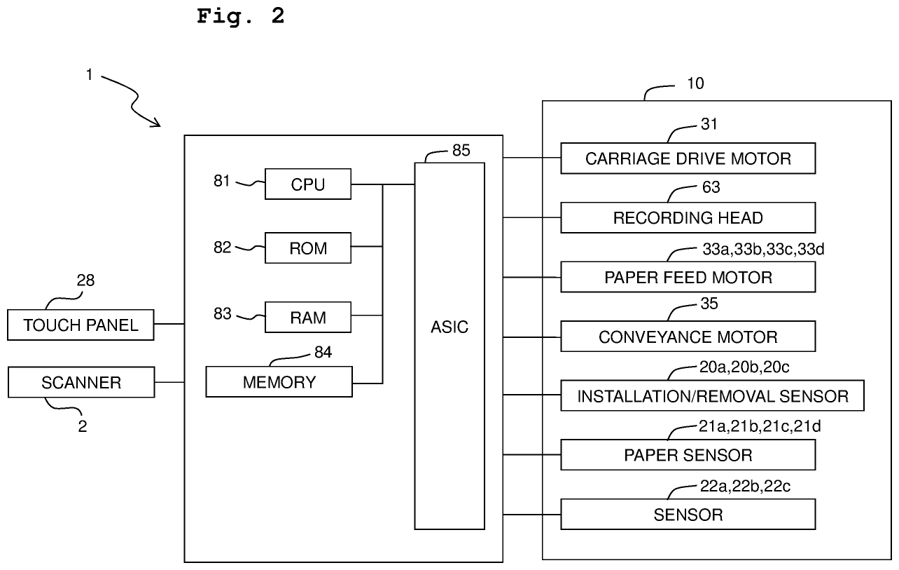

As depicted in FIG. 1, a printer device 10 has a first feed tray 91, a second feed tray 92, a third feed tray 93, a bypass tray 94, a discharge tray 5, a recording unit 6, a conveyance unit 7, a controller 8, and the like. The first to third feed trays 91 to 93, the recording unit 6, the conveyance unit 7, and the controller 8 are contained in the casing 11 of the multifunction apparatus 1. In the casing 11, from the above, there are arranged in the order of the recording unit 6, the third feed tray 93, the second feed tray 92, and the first feed tray 91. Note that although illustration is omitted in FIG. 1, a scanner 2 (see FIG. 2) is arranged above the recording unit 6.

The first to third feed trays 91 to 93 are all removable in the front/rear direction from the opening 13 formed in the front side of the casing 11. Note that the discharge tray 5 is arranged above the third feed tray 93 on the front side to move together with the third feed tray 93. The first to third feed trays 91 to 93 have support surfaces 91a to 93a for supporting recording paper 9, respectively. The bypass tray 94 is arranged to be capable of blocking an opening 14 formed in the rear side of the casing 11. The bypass tray 94 has a base plate 95 having a support surface 94a for supporting the recording paper 9. A revolving shaft 95a is provided at the lower end of the base plate 95 to extend in the left-right direction. The bypass 94 is revolvable about the revolving shaft 95a. The base plate 95 is to revolve from such a position (standup position) depicted with the broken lines in FIG. 1 as in the standup state to a position (inclined position) inclined to the up/down direction. In the inclined position, the support surface 94a faces the upside obliquely with the revolving shaft 95a on the downside. The base plate 95 is disposed at the inclined position to support the recording paper 9.

The casing 11 is provided with installation/removal sensors 20a, 20b, and 20c capable of detecting removal and reinstallation of the first to third feed trays 91 to 93, respectively. It is possible to adopt switches of press button type, for example, for the installation/removal sensors 20a to 20c. That is, if the first feed tray 91 is installed in the casing 11, then a switch is pressed by the first feed tray 91 to become “ON”. If the first feed tray 91 is removed from the casing 11, then the switch is released from the press to become “OFF”. By detecting such ON/OFF state of the switch, it is possible to detect the removal or installation (installation/removal) of the first to third feed trays 91 to 93 with respect to the casing 11.

The first to third feed trays 91 to 93 and the bypass tray 94 are provided with recording paper sensors 21a, 21b, 21c, and 21d for detecting the presence or absence of the recording paper 9 supported by the support surfaces 91a to 94a. It is possible to adopt sensors of light reflective type including light emitting elements and light receiving elements, for example, for the recording paper sensors 21a to 21d. Based on the intensity of reflected light when the detecting areas of the support surfaces 91a to 94a are irradiated with light, the recording paper sensors 21a to 21d detect whether or not there is the recording paper 9 in the detecting areas.

The first to third feed trays 91 to 93 are provided with sensors 22a, 22b, and 22c (see FIG. 2) for detecting the type of the recording paper 9 supported by the support surfaces 91a to 93a. In this embodiment, the sensors 22a to 22c are configured to detect the size of the recording paper 9 supported by the support surfaces 91a to 93a. Note that the sensors 22a to 22c may detect such types of the recording paper as plain paper, glossy paper, postcards, and the like. Alternatively, the sensors 22a to 22c may detect the size of the recording paper 9 supported by the support surfaces 91a to 93a, and the types of the recording paper. It is possible to adopt such sensors for the sensors 22a to 22c, for example, as slidable in a direction orthogonal to the left-right direction on the support surfaces 91a to 93a, and configured to detect the position of a paper guide (not depicted) in contact with edges of the recording paper 9 supported by the support surfaces 91a to 93a. Further, it is also possible for the user to input the type of the recording paper 9 supported by the support surfaces 91a to 93a.

Based on a recording command, the recording unit 6 records some image on the recording paper 9 supplied from any of the first to third feed trays 91 to 93 and the bypass tray 94. In this embodiment, the recording command sent to the recording unit 6 includes designation of the tray to feed the paper. That is, for example, for recording an image of the A4 size, one tray or more are designated, supporting the recording paper 9 of the A4 size among the first to third feed trays 91 to 93 and the bypass tray 94. Hereinbelow, the term “designated tray” will be used to refer to a tray designated by the recording command.

The recording unit 6 has a carriage 61 and a recording head 63. The carriage 61 is supported by two guide rails 67a and 67b provided to extend in the left-right direction. A carriage drive motor 31 (see FIG. 2) moves the carriage 61 reciprocatingly in the left-right direction, which is the main scanning direction, along the two guide rails 67a and 67b. The recording head 63 is mounted on the carriage 61. The recording head 63 jets ink from nozzles (not depicted) provided on a nozzle surface 69 at the downside.

The conveyance unit 7 includes paper feed rollers 50a, 50b, 50c, and 50d, an intermediate roller pair 70, a conveyance roller pair 71, a discharge roller pair 73, a platen 75, and paper guides 16 to 19. The paper feed rollers 50 to 50c are in respective contact with the piece of the recording paper 9 positioned upmost among all pieces of the recording paper 9 supported by the first to third feed trays 91 to 93. A drive force is applied from paper feed motors 33a to 33c (see FIG. 2) to the paper feed rollers 50 to 50c to make the same rotate so as to send out the recording paper 9 in each of the first to third feed trays 91 to 93 to the rear side. Another drive force is applied from a paper feed motor 33d (see FIG. 2) to the paper feed roller 50d to make the same rotate so as to send out the recording paper 9 in the bypass tray 94 toward the opening 14.

The intermediate roller pair 70 is arranged in the vicinity of an upper end portion of the third feed tray 93 at the rear side. The conveyance roller pair 71 and the discharge roller pair 73 are arranged to interpose the recording unit 6 therebetween in the front/rear direction, and the conveyance roller pair 71 is arranged in the rear of the recording unit 6 whereas the discharge roller pair 73 is arranged in front of the recording unit 6. The platen 75 is arranged below the recording unit 6 to face the nozzle surface 69 of the recording unit 6. The intermediate roller pair 70 includes driving rollers 70a and driven rollers 70b, respectively. The conveyance roller pair 71 includes driving rollers 71a and driven rollers 71b, respectively. The discharge roller pair 73 includes driving rollers 73a and driven rollers 73b, respectively. A drive force is applied from a conveyance motor 35 (see FIG. 2) to each of the driving rollers 70a to 73a to make the same rotate. The driven rollers 70b to 73b are driven to rotate following the rotations of the driving rollers 70a to 73a, respectively.

The paper guides 16 to 19 define part of the conveyance path for conveying the recording paper 9 conveyed from the first to third feed trays 91 to 93 and the bypass tray 94, to the recording unit 6. The paper guide 16 upwardly guides the recording paper 9 conveyed from the first feed tray 91 to the rear side by the paper feed roller 50a. The paper guide 16 extends upward from the vicinity of the upper end of the first feed tray 91 at the rear side, to the vicinity of the second feed tray 92. The paper guide 17 upwardly guides the recording paper 9 conveyed from the second feed tray 92 to the rear side by the paper feed roller 50b. The paper guide 17 extends upward from the vicinity of the upper end of the second feed tray 92 at the rear side, to the vicinity of the third feed tray 93. The paper guide 18 guides the recording paper 9 conveyed from the third feed tray 93 to the rear side by the paper feed roller 50c. The paper guide 18 extends upward from the vicinity of the intermediate roller pair 70 to the vicinity of the conveyance roller pair 71.

Between the casing 11 and the rear end surface of the installed second feed tray 92, a part of the conveyance path is defined from the first feed tray 91 to the recording unit 6. Further, between the casing 11 and the rear end surface of the installed third feed tray 93, another part of the conveyance path is defined from the first and second feed trays 91 and 92 to the recording unit 6. Therefore, if the second feed tray 92 is removed from the casing 11, then that part of the conveyance path is no longer defined for conveying, to the recording unit 6, the recording paper 9 conveyed from the first feed tray 91. In this state, a jam is liable to arise if the recording paper 9 is conveyed from the first feed tray 91. Further, if the third feed tray 93 is removed from the casing 11, then that part of the conveyance path is no longer defined for conveying, to the recording unit 6, the recording paper 9 conveyed from the first and second feed tray 91 or 92. In this state, a jam is liable to arise if the recording paper 9 is conveyed from the first feed tray 91 or the second feed tray 92.

The recording paper 9 conveyed rearward from the first feed tray 91 by the paper feed roller 50a is guided upwardly by the paper guide 16. Then, the recording paper 9 passes through between the casing 11 and the rear end surface of the second feed tray 92 and between the casing 11, the guide 17, and the rear end surface of the third feed tray 93, and is then nipped by the intermediate roller pair 70. Then, the recording paper 9 is guided by the paper guide 18 while being conveyed by the intermediate roller pair 70, to arrive at the position of being nipped by the conveyance roller pair 71. The recording paper 9 conveyed rearward from the second feed tray 92 by the paper feed roller 50b is guided upwardly by the paper guide 17. Then, the recording paper 9 passes through between the casing 11 and the rear end surface of the third feed tray 93, and is then nipped by the intermediate roller pair 70. Then, the recording paper 9 is guided by the paper guide 18 while being conveyed by the intermediate roller pair 70, to arrive at the position of being nipped by the conveyance roller pair 71. The recording paper 9 conveyed rearward from the third feed tray 93 by the paper feed roller 50c is nipped by the intermediate roller pair 70. Then, the recording paper 9 is guided by the paper guide 18 while being conveyed by the intermediate roller pair 70, to arrive at the position of being nipped by the conveyance roller pair 71.

The paper guide 19 guides the recording paper 9 conveyed from the bypass tray 94 to the opening 14 by the paper feed roller 50d. The paper guide 19 extends from the vicinity of the opening 14 to the vicinity of the conveyance roller pair 71. The paper guide 19 defines the conveyance path for the recording paper 9 conveyed from the bypass tray 94. The conveyance path defined by the paper guide 19 and the conveyance path defined by the paper guide 18 join together at the upstream side of the conveyance roller pair 71. The recording paper 9 conveyed from the bypass tray 94 by the paper feed roller 50d is sent into the casing 11 via the opening 14. Then, the recording paper 9 is guided by the paper guide 19 to arrive at the position of being nipped by the conveyance roller pair 71.

The recording paper 9, which is conveyed from the first to third feed trays 91 to 93 and the bypass tray 94 and then nipped by the conveyance roller pair 71, is conveyed frontward by the conveyance roller pair 71. The recording paper 9 conveyed frontward by the conveyance roller pair 71 is supported by the platen 75 and, in this state, the image is recorded thereon with the ink being jetted from nozzles (not depicted) of the recording head 63 moving in the main scanning direction. The recording paper 9 finished with the recording is then conveyed frontward by the discharge roller pair 73 and discharged to the discharge tray 5.

The controller 8 is in charge of controlling the whole multifunction apparatus 1. As depicted in FIG. 2, the controller 8 is connected electrically with the carriage drive motor 31, the recording head 63, the paper feed motors 33a to 33d, the conveyance motor 35, the installation/removal sensors 20a to 20c, the recording paper sensors 21a to 21d, the sensors 22a to 22c, and the like, of the printer device 10. Further, the controller 8 is connected with a touch panel 28 and some device related to the scanner 2.

As depicted in FIG. 2, the controller 8 includes a CPU (Central Processing Unit) 81, a ROM (Read Only Memory) 82, a RAM (Random Access Memory) 83, a memory 84, an ASIC (Application Specific Integrated Circuit) 85, and the like. These members cooperate to control the operations of the carriage drive motor 31, the recording head 63, the paper feed motors 33a to 33d, the conveyance motor 35, the touch panel 28, and the like.

The memory 84 stores the priority order of feeding paper to the recording unit 6 from the first to third feed trays 91 to 93. The memory 84 is also referred to as a priority order storage device. For example, consider a case where the priority order is stored in descending of: the third feed tray 93, the second feed tray 92, and the first feed tray 91. If all trays are designated ones, then as far as the third feed tray 93 has the recording paper 9, the paper is fed first from the third feed tray 93. Then, if the third feed tray 93 runs out of the recording paper 9 but the second feed tray 92 has the recording paper 9, then the paper is fed from the second feed tray 92. Further, if the second and third feed trays 92 and 93 run out of the recording paper 9 but the first feed tray 91 has the recording paper 9, then the paper is fed from the first feed tray 91. Note that if only some of the first to third feed trays 91 to 93 is/are designated one(s), then the recording paper 9 is fed from the designated trays according to the priority order stored in the memory 84. What is stored in the memory 84 may or may not be changed at the user's will.

Note that FIG. 2 only shows one CPU 81 and one ASIC 85. However, the controller 8 may include only one CPU 81 and carry out the necessary processes collectively with this one CPU 81, or may include a number of CPUs 81 and carry out the necessary processes with the CPUs 81 in a shared manner. Further, the controller 8 may include only one ASIC 85 and carry out the necessary processes collectively with this one ASIC 85, or may include a number of ASICs 85 and carry out the necessary processes with the ASICs 85 in a shared manner.

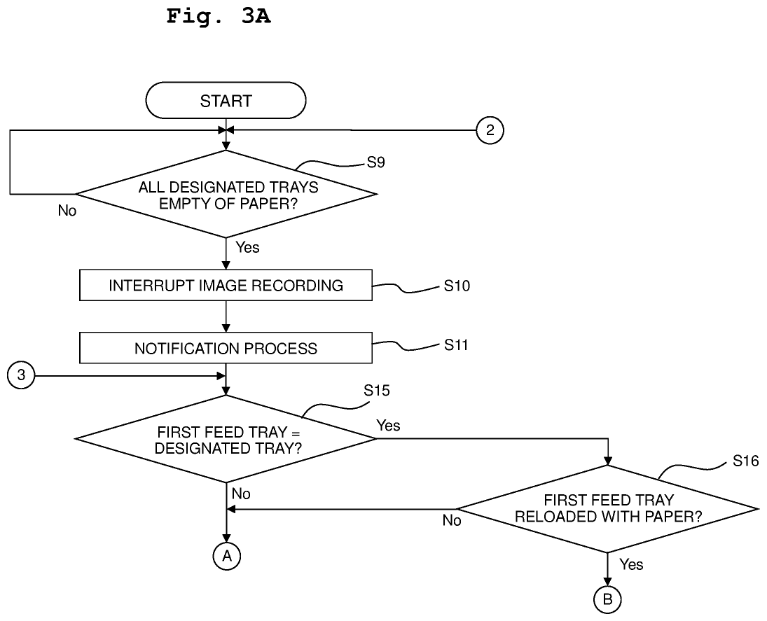

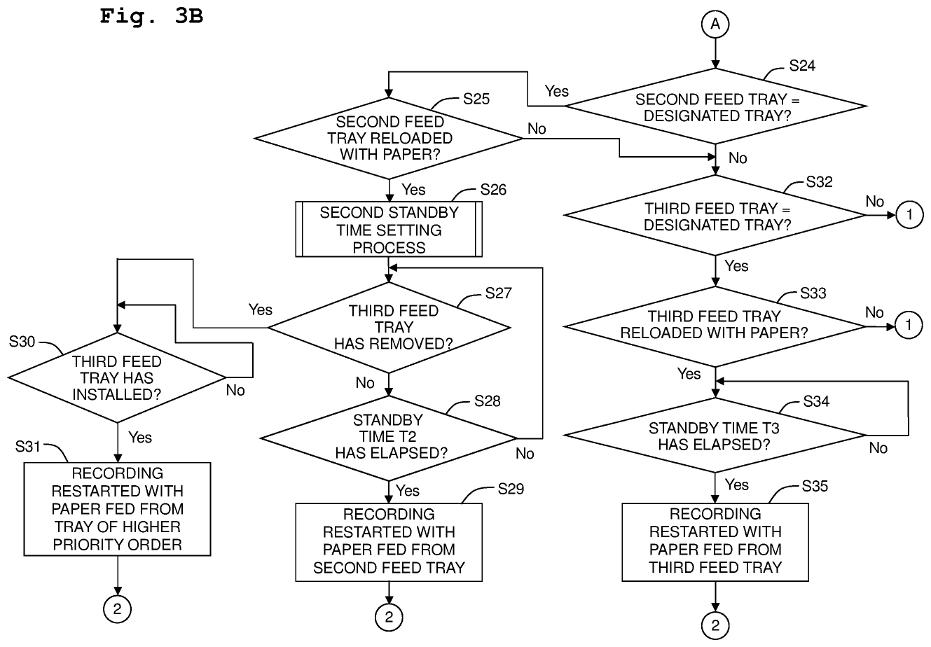

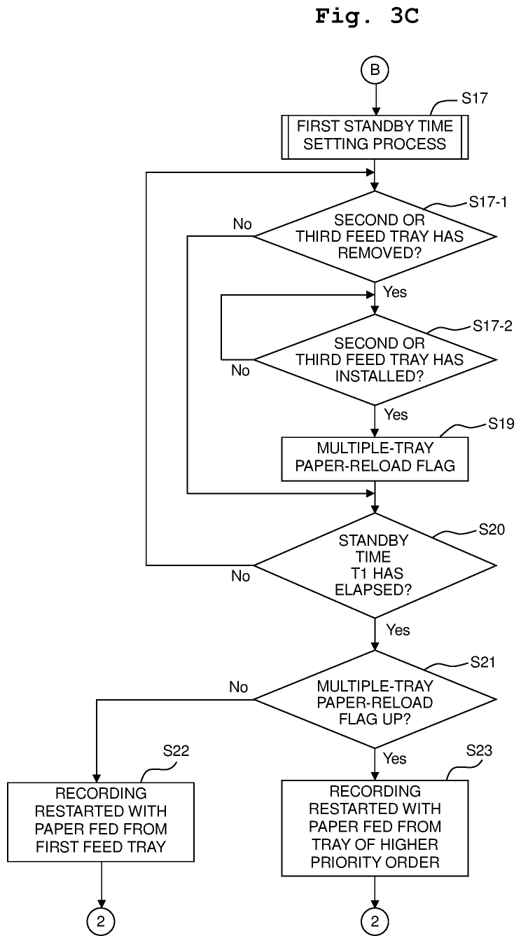

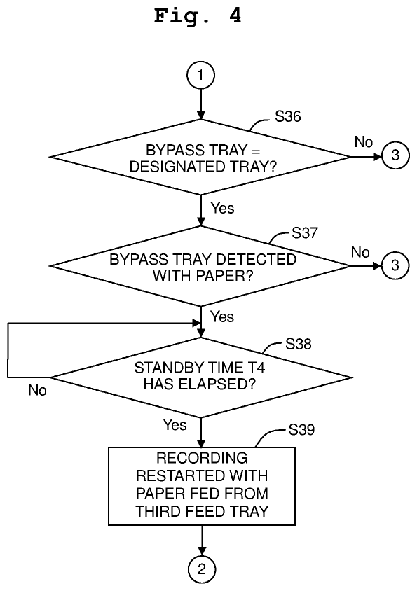

Hereinbelow, referring to FIGS. 3 and 4, an explanation will be made with an example of process carried out by the controller 8 for recording an image in the multifunction apparatus 1. Here, suppose that the memory 84 stores the descending priority order of the third feed tray 93, the second feed tray 92, and the first feed tray 91. That is, with respect to the first to third feed trays 91 to 93 removable from the casing 11, the upper the position, the higher the priority order. While not depicted in the flow chart of FIGS. 3 and 4, based on output signals from the recording paper sensors 21a to 21c, the controller 8 detects whether the recording paper 9 is present or absent in each of the first to third feed trays 91 to 93 in the recording process, and displays the detected result on the touch panel 28.

First, as depicted in FIG. 3, during the continuous recording process, based on the output signals of the recording paper sensors 21a to 21d, the controller 8 repetitively carries out the determination of whether or not all designated trays are empty of the recording paper until all designated trays are empty of the recording paper (S9). If the controller 8 determines that all designated trays are empty of the recording paper (S9: Yes), then the controller 8 interrupts the image recording in the recording unit 6 (S10), and carries out an aftermentioned notification process (S11).

Then, the controller 8 determines whether or not the first feed tray 91 is a designated tray (S15). If the controller 8 determines that the first feed tray 91 is a designated tray (S15: Yes), then based on the output signal of the installation/removal sensor 20a, then the controller 8 detects the removal and reinstallation of the first feed tray 91. Further, based on the output signal of the recording paper sensor 21a, the controller 8 determines whether or not the first feed tray 91 has the recording paper 9 (S16). That is, in the step S16, the controller 8 determines whether or not the first feed tray 91 is reload with the recording paper. If the controller 8 determines that the first feed tray 91 is not reload with the recording paper (S16: No), then the process proceeds to an aftermentioned step S24. If the controller 8 determines that the first feed tray 91 is reloaded with the recording paper (S16: Yes), then the controller 8 carries out an aftermentioned first standby time setting process to set up a standby time T1 (S17). Here, the phrase “set up” refers to causing the RAM 83 to store the derived standby time T1.

Then, the controller 8 determines whether the second feed tray 92 or the third feed tray 93 is removed (S17-1). If the controller 8 determines that the second feed tray 92 and the third feed tray 93 are not removed (S17-1: No), then the process proceeds to an aftermentioned step S20. On the other hand, if the controller 8 determines that the second feed tray 92 or the third feed tray 93 is removed (S17-1: Yes), then the controller 8 repetitively carries out the determination of whether or not the tray determined earlier as removed is reinstalled until it is reinstalled (S17-2). Then, if the controller 8 determines that the second feed tray 92 or the third feed tray 93 is reinstalled (S17-2: Yes), then a multiple-tray paper-reload flag is set up (S19). Then, the controller 8 determines whether or not the standby time T1 set in the step S17 has elapsed (S20). That is, the controller 8 measures the passage of time from the point of detecting the paper reload in the step S16, and determines whether or not the standby time T1 has elapsed. If the controller 8 determines that the standby time T1 has not yet elapsed (S20: No), then the process returns to the step S17-1.

If the controller 8 determines that the standby time T1 has elapsed in the step S20 (S20: Yes), then it determines whether or not the multiple-tray paper-reload flag is set up (S21). If the controller 8 determines that the multiple-tray paper-reload flag is not set up (S21: No), then the image recording is restarted with the paper fed from the first feed tray 91 (S22). If the controller 8 determines that the multiple-tray paper-reload flag is set up (S21: Yes), then the image recording is restarted with the paper fed from the tray of the highest priority order among the designated trays supporting the recording paper 9 (S23). That is, the controller 8 determines whether or not the second feed tray 92 and the third feed tray 93 satisfy the condition of being the designated trays and supporting the recording paper 9. Then, the paper is fed from the third feed tray 93 if the third feed tray 93 of the highest priority order satisfies the condition. Alternatively, the paper is fed from the second feed tray 92 if the third feed tray 93 does not satisfy the condition but the second feed tray 92 satisfies the condition. Still alternatively, the paper is fed from the first feed tray 91 if both the third feed tray 93 and the second feed tray 92 do not satisfy the condition. After the steps S22 and S23, the process returns to the step S9.

In the step S15, if the controller 8 determines that the first feed tray 91 is not a designated tray (S15: No), then the controller 8 determines that whether or not the second feed tray 92 is a designated tray (S24). If the controller 8 determines that the second feed tray 92 is a designated tray (S24: Yes), then based on the output signal of the installation/removal sensor 20b, if the removal and reinstallation of the second feed tray 92 are detected and, based on the output signal of the recording paper sensor 21b, the controller 8 determines whether or not the second feed tray 92 has the recording paper 9 (S25). That is, in the step S25, the controller 8 determines whether or not the second feed tray 92 is reloaded with the recording paper. If the controller 8 determines that the second feed tray 92 is not reloaded with the recording paper (S25: No), then the process proceeds to an aftermentioned step S32. On the other hand, if the controller 8 determines that the second feed tray 92 is reloaded with the recording paper (S25: Yes), then the controller 8 carries out an aftermentioned second standby time setting process to set up a standby time T2 (S26). Note that the standby time T2 set in the second standby time setting process is shorter than the standby time T1 set in the first standby time setting process.

Then, the controller 8 determines whether or not the third feed tray 93 is removed (S27). If the controller 8 determines that the third feed tray 93 is not removed (S27: No), then the controller 8 determines whether or not the standby time T2 set up in the step S26 has elapsed (S28). That is, the controller 8 measures the passage of time from the point of detecting the paper reload in the step S25, and determines whether or not the standby time T2 has elapsed. If the controller 8 determines that the standby time T2 has not yet elapsed (S28: No), then the process returns to the step S27. If the controller 8 determines that the standby time T2 has elapsed (S28: Yes), then the image recording is restarted with the paper fed from the second feed tray 92 (S29). After the step S29, the process returns to the step S9.

If the controller 8 determines in the step S27 that the third feed tray 93 is removed (S27: Yes), then the controller 8 repetitively carries out the determination of whether or not the third feed tray 93 is reinstalled until it is reinstalled (S30). Then, if the controller 8 determines that the third feed tray 93 is reinstalled (S30: Yes), then the image recording is restarted with the paper fed from the tray of the highest priority order among the designated trays supporting the recording paper 9 (S31). That is, the controller 8 determines whether or not the third feed tray 93 satisfies the condition of being the designated trays and supporting the recording paper 9. Then, the paper is fed from the third feed tray 93 if the third feed tray 93 of the highest priority order satisfies the condition. Alternatively, the paper is fed from the second feed tray 92 if the third feed tray 93 does not satisfy the condition. After the steps S31, the process returns to the step S9.

In the step S24, if the controller 8 determines that the second feed tray 92 is not a designated tray (S24: No), then the controller 8 determines whether or not the third feed tray 93 is a designated tray (S32). If the controller 8 determines that the third feed tray 93 is not a designated tray (S32: No), then the process proceeds to an aftermentioned step S36. On the other hand, if the controller 8 determines that the third feed tray 93 is a designated tray (S32: Yes), then the controller 8 determines whether or not the removal and reinstallation of the third feed tray 93 are detected based on the output signal of the installation/removal sensor 20c, and whether or not the third feed tray 93 has the recording paper 9 based on the output signal of the recording paper sensor 21c (S33). That is, in the step S33, the controller 8 determines whether or not the third feed tray 93 is reloaded with the recording paper. If the controller 8 determines that the third feed tray 93 is not reloaded with the recording paper (S33: No), then the process proceeds to the aftermentioned step S36. On the other hand, if the controller 8 determines that the third feed tray 93 is reloaded with the recording paper (S33: Yes), then the controller 8 sets up a standby time T3, and repetitively carries out the determination of whether or not the standby time T3 has elapsed until the standby time T3 is determined as elapsed (S34). That is, the controller 8 measures the passage of time from the point of detecting the paper reload in the step S33, and determines whether or not the standby time T3 has elapsed. Note that the standby time T3 is shorter than the standby time T2, or even may be zero. If the controller 8 determines that the standby time T3 has elapsed (S34: Yes), then the image recording is restarted with the paper fed from the third feed tray 93 (S35). After the step S35, the process returns to the step S9.

As depicted in FIG. 4, after the controller 8 determines that the third feed tray 93 is not a designated tray in the step S32 and after the controller 8 determines that the third feed tray 93 is not reloaded with the recording paper in the step S33, the controller 8 determines whether or not the bypass tray 94 is a designated tray (S36). If the controller 8 determines that the bypass tray 94 is not a designated tray (S36: No), then the process returns to the step S15. If the controller 8 determines that the bypass tray 94 is a designated tray (S36: Yes), then the controller 8 determines whether or not the recording paper 9 is detected in the bypass tray 94 based on the output signal from the recording paper sensor 21d. That is, the controller 8 determines whether or not the bypass tray 94 has changed from having not the recording paper 9 to having the recording paper 9 (S37).

If in the step S37 the controller 8 determines that the recording paper 9 is not detected in the bypass tray 94 (S37: No), then the process returns to the step S15. On the other hand, if the controller 8 determines that the recording paper 9 is detected in the bypass tray 94 in the step S37 (S37: Yes), then then the controller 8 sets up a standby time T4, and repetitively carries out the determination of whether or not the standby time T4 has elapsed until the standby time T4 is determined as elapsed (S38). That is, the controller 8 measures the passage of time from the point of detecting the paper in the step S37, and determines whether or not the standby time T4 has elapsed. Note that in this embodiment, the standby time T4 is longer than the standby times T3. The standby time T4 may be set longer than the aftermentioned standby time T1 or T2. If the controller 8 determines that the standby time T4 has elapsed (S38: Yes), then the image recording is restarted with the paper fed from the bypass tray 94 (S39). After the step S39, the process returns to the step S9.

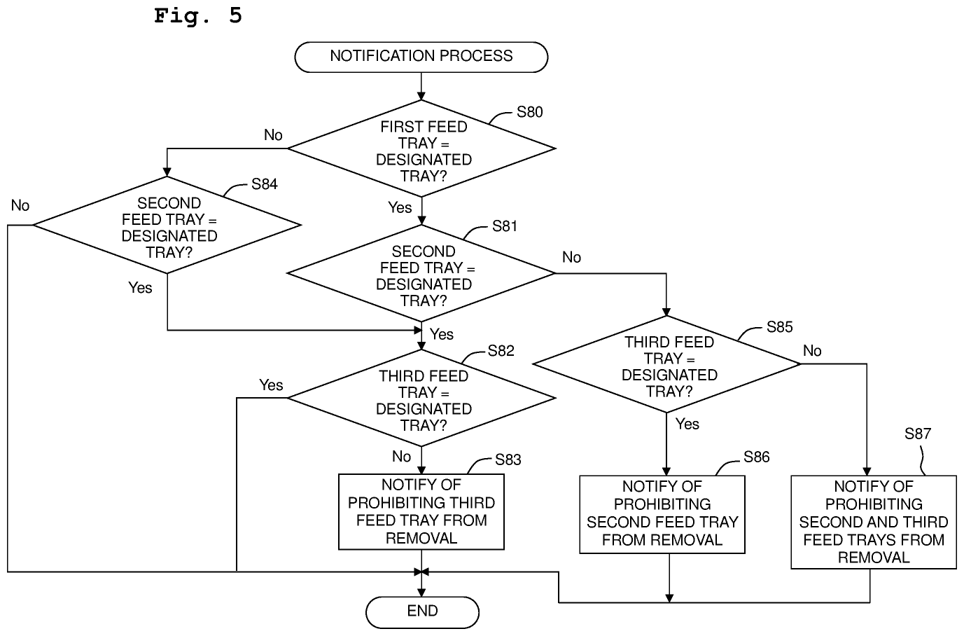

Next, referring to FIG. 5, an explanation will be made on the notification process carried out in the step S11 (FIG. 3) mentioned earlier on. First, the controller 8 determines whether or not the first feed tray 91 is a designated tray (S80). If the controller 8 determines that the first feed tray 91 is a designated tray (S80: Yes), then the controller 8 successively determines whether or not the second feed tray 92 is a designated tray (S81). If the controller 8 determines that the second feed tray 92 is a designated tray (S81: Yes), then the controller 8 further determines whether or not the third feed tray 93 is a designated tray (S82). If the controller 8 determines that the third feed tray 93 is a designated tray (S82: Yes), that is, if the first to third feed trays 91 to 93 are all designated trays, then the process is ended. On the other hand, if the controller 8 determines in the step S82 that the third feed tray 93 is not a designated tray (S82: No), that is, if the first and second feed trays 91 and 92 are designated trays but the third feed tray 93 is not a designated tray, then the controller 8 causes the touch panel 28 to display a message for notifying the user that the third feed tray 93 is prohibited from removal (S83). After the step S83, the process is ended.

Further, if the controller 8 determines in the step S80 that the first feed tray 91 is not a designated tray (S80: No), then the controller 8 determines whether or not the second feed tray 92 is a designated tray (S84). If the controller 8 determines that the second feed tray 92 is not a designated tray (S84: No), that is, if the first and second feed trays 91 and 92 are not designated trays, then the process is ended. On the other hand, if the controller 8 determines that the third feed tray 92 is a designated tray (S84: Yes), then the process proceeds to the step S82. That is, in the successive step S82, if the controller 8 determines that the third feed tray 93 is a designated tray, i.e., if the first feed tray 91 is not a designated tray but the second and third feed trays 92 and 93 are designated trays, then the process is ended. Further, in the step S82 after the determination of the step S84, if the controller 8 determines that the third feed tray 93 is not a designated tray, i.e., if the first and third feed trays 91 and 93 are not a designated tray but the second feed tray 92 is a designated tray, then in the step S83, the controller 8 causes the touch panel 28 to notify the user that the third feed tray 93 is prohibited from removal.

Further, if the controller 8 determines in the step S81 that the second feed tray 92 is not a designated tray (S81: No), then the controller 8 determines whether or not the third feed tray 93 is a designated tray (S85). If the third feed tray 93 is determined in the step S85 as a designated tray (S85: Yes), that is, if the first and third feed trays 91 and 93 are designated trays but the second feed tray 92 is not a designated tray, then the controller 8 causes the touch panel 28 to display a message for notifying the user that the second feed tray 92 is prohibited from removal (S86). After the step S86, the process is ended. On the other hand, in the step S85, if the controller 8 determines that the third feed tray 93 is not a designated tray (S85: No), that is, if the first feed tray 91 is a designated tray but the second and third feed trays 92 and 93 are not designated trays, then the controller 8 causes the touch panel 28 to display a message for notifying the user that the second and third feed trays 92 and 93 are prohibited from removal (S87). After the step S87, the process is ended.

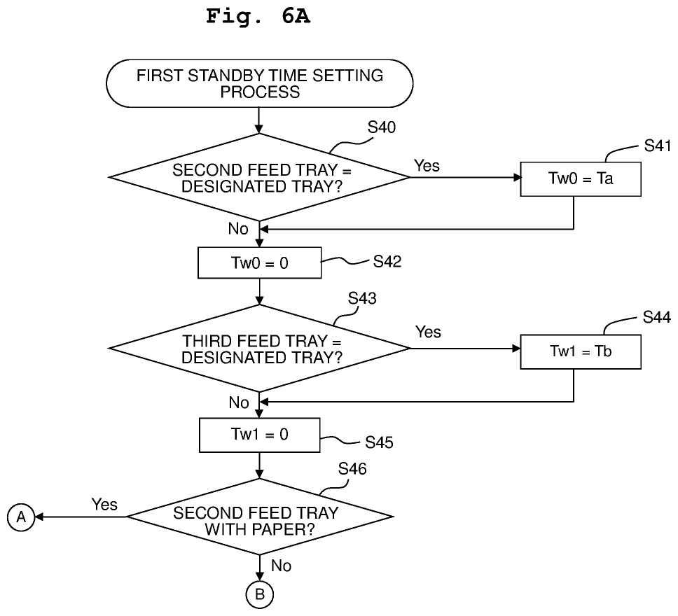

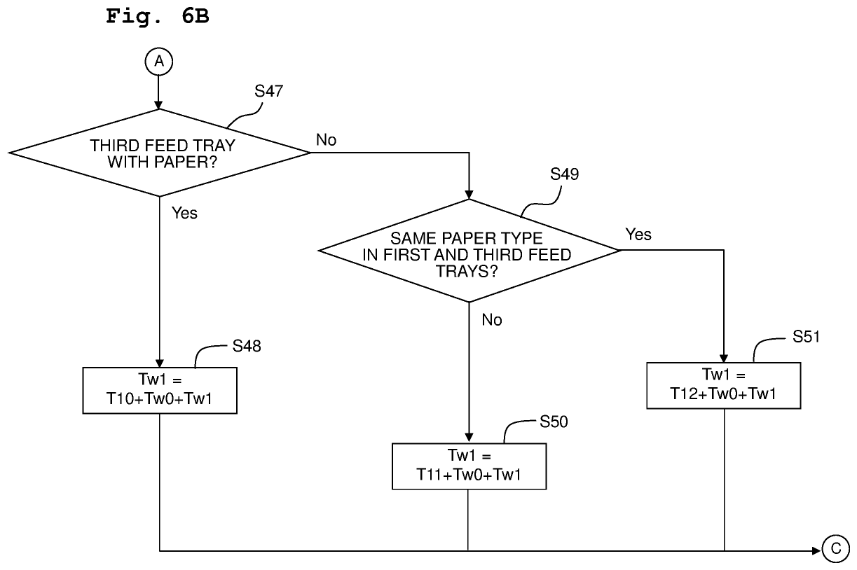

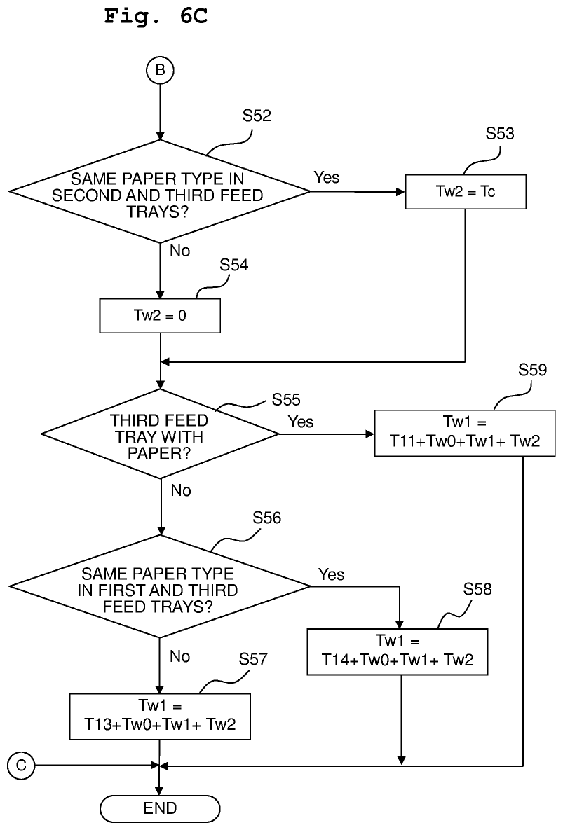

Next, referring to FIG. 6, an explanation will be made on the first standby time setting process carried out in the aforementioned step S17 (FIG. 3). The first standby time setting process is configured for setting the standby time T1 from the detection of reloading the first feed tray 91 with the recording paper 9 to the restart of the image recording.

First, the controller 8 determines whether or not the second feed tray 92 is a designated tray (S40). If the controller 8 determines that the second feed tray 92 is a designated tray (S40: Yes), then the controller 8 sets Tw0=Ta (Ta is a positive number) (S41), and the process proceeds to the step S43 described later on. If the controller 8 determines that the second feed tray 92 is not a designated tray (S40: No), then the controller 8 sets Tw0=0 (S42). Next, the controller 8 determines whether or not the third feed tray 93 is a designated tray (S43). If the controller 8 determines that the third feed tray 93 is a designated tray (S43: Yes), then the controller 8 sets Tw1=Tb (Tb is a positive number) (S44), and the process proceeds to the step S46 described later on. If the controller 8 determines that the third feed tray 93 is not a designated tray (S43: No), then the controller 8 sets Tw1=0 (S45).

Next, based on the output signal from the recording paper sensor 21b, the controller 8 determines whether or not the second feed tray 92 has the recording paper 9 (S46). If the controller 8 determines that the second feed tray 92 has the recording paper 9 (S46: Yes), then based on the output signal from the recording paper sensor 21c, the controller 8 determines whether or not the third feed tray 93 has the recording paper 9 (S47). If the controller 8 determines that the third feed tray 93 has the recording paper 9 (S47: Yes), then the controller 8 sets T10+Tw0+Tw1 (T10 is a positive number) to the standby time T1 (S48), and then the process is ended.

On the other hand, if the controller 8 determines that the third feed tray 93 does not have the recording paper 9 (S47: No), then based on the output signals of the sensors 22a and 22c, the controller 8 determines whether or not the type of the recording paper 9 supported by the first feed tray 91 is the same as the type of the recording paper 9 supported by the third feed tray 93 (S49). If the controller 8 determines that the recording paper 9 in the first and third feed trays 91 and 93 is different in type (S49: No), then the controller 8 sets T11+Tw0+Tw1 (T11>T10) to the standby time T1 (S50), and then the process is ended. If the controller 8 determines that the recording paper 9 in the first and third feed trays 91 and 93 is the same in type (S49: Yes), then the controller 8 sets T12+Tw0+Tw1 (T12>T11) to the standby time T1 (S51), and then the process is ended.

Further, in the step S46, if the controller 8 determines that the second feed tray 92 does not have the recording paper 9 (S46: No), then based on the output signals of the sensors 22a and 22b, the controller 8 determines whether or not the type of the recording paper 9 supported by the first feed tray 91 is the same as the type of the recording paper 9 supported by the second feed tray 92 (S52). If the controller 8 determines that the recording paper 9 in the first and second feed trays 91 and 92 is the same in type (S52: Yes), then the controller 8 sets Tw2=Tc (Tc is a positive number) (S53), and the process proceeds to the aftermentioned step S55. On the other hand, if the controller 8 determines that the recording paper 9 in the first and second feed trays 91 and 92 is not the same in type (S52: No), then the controller 8 sets Tw2=0 (S54).

Then, based on the output signal of the recording paper sensor 21c, the controller 8 determines whether or not the third feed tray 93 has the recording paper 9 (S55). If the controller 8 determines that the third feed tray 93 does not have the recording paper 9 (S55: No), then based on the output signals of the sensors 22a and 22c, the controller 8 determines whether or not the type of the recording paper 9 supported by the first feed tray 91 is the same as the type of the recording paper 9 supported by the third feed tray 93 (S56). If the controller 8 determines that the recording paper 9 in the first and third feed trays 91 and 93 is different in type (S56: No), then the controller 8 sets T13+Tw0+Tw1+Tw2 (T13>T12) to the standby time T1 (S57), and then the process is ended. If the controller 8 determines that the recording paper 9 in the first and third feed trays 91 and 93 is the same in type (S56: Yes), then the controller 8 sets T14+Tw0+Tw1+Tw2 (T14>T13) to the standby time T1 (S58), and then the process is ended. Further, in the step S55, if the controller 8 determines that the third feed tray 93 has the recording paper 9 (S55: Yes), then the controller 8 sets T11+Tw0+Tw1+Tw2 to the standby time T1 (S59), and then the process is ended.

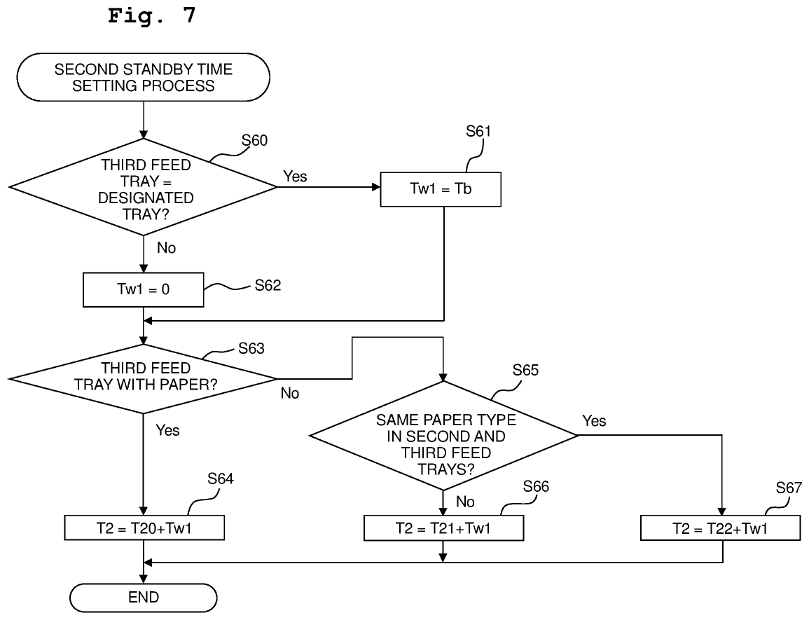

Next, referring to FIG. 7, an explanation will be made in detail on the second standby time setting process carried out in the aforementioned step S26 (FIG. 3). The second standby time setting process is configured for setting the standby time T2 from the detection of reloading the second feed tray 92 with the recording paper 9 to the restart of the image recording.

First, the controller 8 determines whether or not the third feed tray 93 is a designated tray (S60). If the controller 8 determines that the third feed tray 93 is a designated tray (S60: Yes), then the controller 8 sets Tw1=Tb (Ta is a positive number) (S61), and the process proceeds to the step S63 described later on. On the other hand, if the controller 8 determines that the third feed tray 93 is not a designated tray (S60: No), then the controller 8 sets Tw1=0 (S62). Next, based on the output signal from the recording paper sensor 21c, the controller 8 determines whether or not the third feed tray 93 has the recording paper 9 (S63). If the controller 8 determines that the third feed tray 93 has the recording paper 9 (S63: Yes), then the controller 8 sets T20+Tw1 (T20 is a positive number) to the standby time T2 (S64), and then the process is ended.

On the other hand, if the controller 8 determines that the third feed tray 93 does not have the recording paper 9 (S63: No), then based on the output signals of the sensors 22b and 22c, the controller 8 determines whether or not the type of the recording paper 9 supported by the second feed tray 92 is the same as the type of the recording paper 9 supported by the third feed tray 93 (S65). If the controller 8 determines that the recording paper 9 in the second and third feed trays 92 and 93 is different in type (S65: No), then the controller 8 sets T21+Tw1 (T21>T20) to the standby time T2 (S66), and then the process is ended. Further, if the controller 8 determines that the recording paper 9 in the second and third feed trays 92 and 93 is the same in type (S65: Yes), then the controller 8 sets T22+Tw1 (T22>T21) to the standby time T2 (S67), and then the process is ended.

In the above manner, the multifunction apparatus 1 of the above embodiment interrupts the image recording if all designated trays run out of the recording paper. Then, if the third feed tray 93 is the earliest one of the designated trays whose removal and reinstallation are detected, then the image recording is restarted with the paper fed from the third feed tray 93 after the standby time T3 has elapsed since the detection of the removal and reinstallation. Further, if the second feed tray 92 is the earliest one of the designated trays whose removal and reinstallation are detected after the interruption, then the image recording is restarted with the paper fed from the second feed tray 92 if the removal of the third feed tray 93 is not detected within the standby time T2 longer than the standby time T3 from the detection of the removal and reinstallation. Further, if the first feed tray 91 is the earliest one of the designated trays whose removal and reinstallation are detected after the interruption, then the image recording is restarted with the paper fed from the first feed tray 91 if the removal of the second feed tray 92 or the third feed tray 93 is not detected within the standby time T1 longer than the standby time T2 from the detection of the removal and reinstallation. Therefore, when an interruption process is carried out, no special work is necessary for restarting the image recording, because it is possible to automatically restart the image recording based on the detection of removing and reinstalling the first feed tray 91, the second feed tray 92, or the third feed tray 93. Further, after reloading the first feed tray 91 with the recording paper 9, the user may possibly reload the recording paper 9 successively into the second feed tray 92 or the third feed tray 93 defining part of the conveyance path from the first feed tray 91 to the recording unit 6. Further, after reloading the second feed tray 92 with the recording paper 9, the user may possibly reload the recording paper 9 successively into the third feed tray 93 defining part of the conveyance path from the second feed tray 92 to the recording unit 6. Therefore, the standby time T1 and the standby time T2 are set longer than the standby time T1 such that if the first feed tray 91 or the second feed tray 92 is detected as first removed from and reinstalled into the casing 11, then the image recording will not be restarted during the period of a high possibility for the user to successively remove and reinstall the second feed tray 92 or the third feed tray 93. During that period, if the second feed tray 92 or the third feed tray 93 is removed, then the image recording will not be restarted with the paper fed from the first feed tray 91 or the second feed tray 92 such that it is possible to prevent jam from arising from the removal of the second feed tray 92 or the third feed tray 93 from the casing 11 after the image recording is restarted.

Further, in the multifunction apparatus 1 of the above embodiment, the standby time T2 is longer in the case of the second feed tray 92 and the third feed tray 93 being designated trays (S60: Yes in FIG. 7) than in the case of the second feed tray 92 being a designated tray but the third feed tray 93 being not a designated tray (S60: No in FIG. 7). Therefore, when it is less possible for the third feed tray 93 to be removed, the standby time T2 can be shortened such that it is possible to restart the image recording quickly.

Further, in the multifunction apparatus 1 of the above embodiment, the standby time T2 is shorter in the case of the third feed tray 93 supporting the recording paper 9 (S63: Yes in FIG. 7) than in the case of the third feed tray 93 not supporting the recording paper 9 (S63: No in FIG. 7). Therefore, it is less possible to reload the recording paper 9 in the case of the third feed tray 93 supporting the recording paper 9 than in the case of the third feed tray 93 not supporting the recording paper 9, such that it is possible to shorten the standby time T2 to allow for a quick restart of the image recording.

Further, in the multifunction apparatus 1 of the above embodiment, if the third feed tray 93 does not support the recording paper 9, then the standby time T2 is shorter in the case of the recording paper 9 supported by the second feed tray 92 and the third feed tray 93 being different in type (S65: No in FIG. 7) than in the case of the recording paper 9 being the same in type (S65: Yes in FIG. 7). Therefore, it is less possible to reload the recording paper 9 in the case of the recording paper 9 supported by the second feed tray 92 and the third feed tray 93 being different in type than in the case of the recording paper 9 being the same in type, such that it is possible to shorten the standby time T2 to allow for a quick restart of the image recording.

In addition, in the multifunction apparatus 1 of the above embodiment, if the first feed tray 91 is the earliest one of the designated trays whose removal and reinstallation are detected after the interruption, then the image recording is restarted with the paper fed from the first feed tray 91 if the removal of the second feed tray 92 or the third feed tray 93 is not detected within the standby time T1 longer than the standby time T2 from the detection of the removal and reinstallation. If the first feed tray 91 is first reloaded with the recording paper 9, then the user may next reload the recording paper 9 into either the second feed tray 92 or the third feed tray 93. Hence, taking the user's burdensome work into consideration, if the standby time T1 is set longer than the standby time T2 for first reloading the second feed tray 92 with the recording paper 9, then it is possible to effectively prevent the jam from arising.

Further, in the multifunction apparatus 1 of the above embodiment, the first to third feed trays 91 to 93 are provided with the memory 84 to store the priority order of feeding the recording paper 9 to the recording unit 6. Therefore, it is possible to designate a tray to feed the paper preferentially out of one or more trays under the recording command.

In addition, in the multifunction apparatus 1 of the above embodiment, after the image recording is interrupted, if the bypass tray 94 turns from not having the recording paper 9 to having the recording paper 9, then after the standby time T4 longer than the standby time T3 has elapsed, the image recording is restarted with the paper fed from the bypass tray 94. Therefore, even if the bypass tray 94 is reloaded with the recording paper 9, it is still possible to restart the image recording automatically. Further, because the user can prepare the recording paper 9 in a correct orientation during the standby time T4, the precision of paper feed will increase.

Further, in the multifunction apparatus 1 of the above embodiment, if the second feed tray 92 is a designated tray but the third feed tray 93 is not a designated tray under the recording command, then the message is displayed to notify the user that the third feed tray 93 is prohibited from removal (S86 of FIG. 5). Therefore, it is possible to reliably prevent a jam from arising.

Hereinabove, based on the accompanied drawings, an embodiment of the present disclosure was explained. However, it shall be considered that any specific configuration is not limited to that embodiment. The scope of the present disclosure is set forth in the appended claims but not in the above explanation of the embodiment and, furthermore, the scope includes all possible changes and modifications equivalent in meaning to and within the scope of the claims.

In the above embodiment, the explanation was made with the case of changing the lengths of the standby times T1 and T2 under the three conditions: whether or not the tray positioned above the detected tray of removal and reinstallation is a designated one, whether or not the recording paper 9 is supported there, and whether or not the recording paper 9 supported there has the same type as the recording paper 9 supported by the detected tray of removal and reinstallation. However, the method for setting up the standby times T1 and T2 is not limited to that. The lengths of the standby times T1 and T2 may be changed on the basis of only part of the above three conditions, or the standby times T1 and T2 may be fixed in length.

Further, in the above embodiment, the explanation was made with the case of the standby times T1, T2, and T3 being different. However, without being limited to that, at least it suffices that the standby times T1 and T2 are longer than the standby time T3.

Further, in the above embodiment, the explanation was made with the case where the paper is fed from the tray in a higher priority order stored in the memory 84 when the image recording is restarted. However, without being limited to that, for example, the paper may be fed from the tray which is first removed and reinstalled after the interruption.

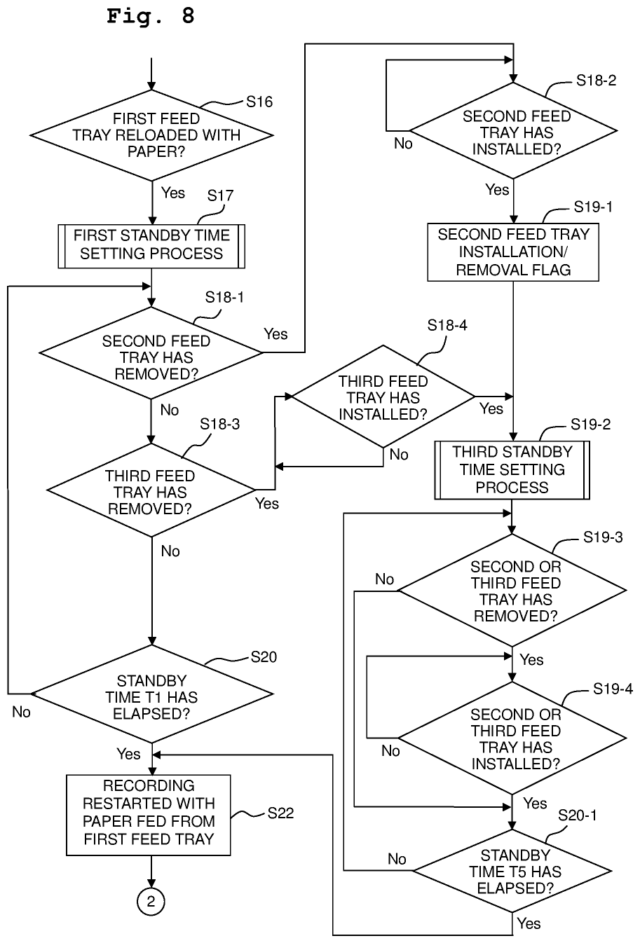

In addition, in the above embodiment, the explanation was made with the case where the image recording is restarted after the standby time T1 has elapsed no matter whether the second feed tray 92 or the third feed tray 93 is detected as removed or the second feed tray 92 or the third feed tray 93 is not detected as removed in the step S17-1, after the controller 8 determines in the step S16 of FIG. 3 that the first feed tray 91 is reloaded with the recording paper, and the controller 8 carries out the first standby time setting process in the step S17. However, without being limited to that, a modified example of the process procedure carried out by the controller 8 will be depicted here in FIG. 8. FIG. 8 shows such a part of the process as to correspond to the flow chart of FIG. 3 from the step S16. Here, suppose that the memory 84 stores the descending priority order of the first feed tray 91, the second feed tray 92, and the third feed tray 93. That is, the lower the position, the higher the priority order of the first to third feed trays 91, 92, and 93 removable from the casing 11.

As depicted in FIG. 8, after the controller 8 determines in the step S16 that the first feed tray 91 is reloaded with the recording paper, and carries out the first standby time setting process in the step S17, the controller 8 detects whether or not the second feed tray 92 is removed (S18-1). If the controller 8 determines that the second feed tray 92 is not removed (S18-1: No), then the controller 8 detects whether or not the third feed tray 93 is removed (S18-3). If the controller 8 determines that the third feed tray 93 is not removed (S18-3: No), then in the same manner as in the step S20 of FIG. 3, the controller 8 determines whether or not the standby time T1 has elapsed (S20). If the controller 8 determines that the standby time T1 has not yet elapsed (S20: No), then the process returns to the step S18-1. On the other hand, if the controller 8 determines that the standby time T1 has elapsed (S20: Yes), then in the same manner as in the step S22 of FIG. 3, the image recording is restarted with the paper fed from the first feed tray 91 (S22).

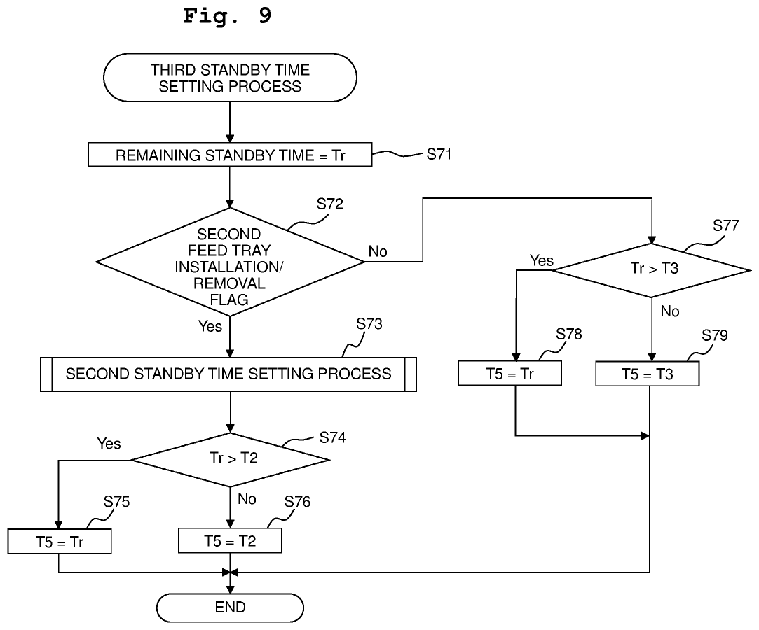

If the controller 8 determines in the step S18-1 that the second feed tray 92 is removed (S18-1: Yes), then the controller 8 repetitively carries out the determination of whether or not the second feed tray 92 is reinstalled until it is determined as reinstalled (S18-2). If the controller 8 determines that the second feed tray 92 is reinstalled (S18-2: Yes), then the controller 8 sets up a second feed tray installation/removal flag (S19-1), and the process proceeds to the step S19-2. Further, if the controller 8 determines in the step S18-3 that the third feed tray 93 is removed (S18-3: Yes), then the controller 8 repetitively carries out the determination of whether or not the third feed tray 93 is reinstalled until it is determined as reinstalled (S18-4). If the controller 8 determines that the third feed tray 93 is reinstalled (S18-4: Yes), then the process proceeds to the step S19-2. In the step S19-2, the controller 8 carries out a third standby time setting process depicted in FIG. 9 to set up a standby time T5.

Then, the controller 8 determines whether or not the second feed tray 92 or the third feed tray 93 is removed (S19-3). If the controller 8 determines that neither the second feed tray 92 nor the third feed tray 93 is removed (S19-3: No), then the process proceeds to the aftermentioned step S20-1. If the controller 8 determines that the second feed tray 92 or the third feed tray 93 is removed (S19-3: Yes), then the controller 8 repetitively carries out the determination of whether or not the removed tray is reinstalled until it is determined as reinstalled (S19-4). Then, if the controller 8 determines that the second feed tray 92 or the second feed tray 93 is reinstalled (S19-4: Yes), then after detecting the reinstallation of the second feed tray 92 in the step S18-2, or after detecting the reinstallation of the third feed tray 93 in the step S18-4, the controller 8 determines whether or not the standby time T5 has elapsed (S20-1). If the controller 8 determines that the standby time T5 has not yet elapsed (S20-1: No), then the process returns to the step S19-3. If the controller 8 determines that the standby time T5 has elapsed (S20-1: Yes), then in the same manner as in the step S22 of FIG. 3, the image recording is restarted with the paper fed from the first feed tray 91 (S22).

Next, referring to FIG. 9, an explanation will be made in detail on the third standby time setting process carried out in the aforementioned step S19-2 (FIG. 8). The third standby time setting process is configured for setting the standby time T5 till the restart of the image recording, during the measuring of the standby time T1 after the detection of removing and reinstalling the first feed tray 91, if the second feed tray 92 or the third feed tray 93 is detected as removed and then reinstalled.

First, at the point of time of detecting installation of the second feed tray 92 in the step S18-2 of FIG. 8 or at the point of time of detecting installation of the third feed tray 93 in the step S18-4, Tr is set as the remaining time of the standby time T1 (S71). Next, the controller 8 determines whether or not the second feed tray installation/removal flag (see the step S19-1 of FIG. 8) is set up (S72). If the controller 8 determines that the second feed tray installation/removal flag is up (S72: Yes), then the second standby time setting process is carried out (S73: see FIG. 7 for the detail). Then, the controller 8 determines whether or not Tr set in the step S71 is longer than T2 set in the second standby time setting process of the step S73 (S74). If the controller 8 determines that Tr is longer than T2 (S74: Yes), then the controller 8 sets the standby time T5 to Tr (S75), and then the process is ended. On the other hand, if the controller 8 determines that Tr is not longer than T2 (S74: No), then the controller 8 sets the standby time T5 to T2 (S76), and then the process is ended. Further, if the controller 8 determines that the second feed tray installation/removal flag is not up (S72: No), then the controller 8 determines whether or not Tr set in the step S71 is longer than T3 (T3 is the same as the standby time T3 in the step S34 of FIG. 3) (S77). If the controller 8 determines that Tr is longer than T3 (S77: Yes), then the controller 8 sets the standby time T5 to Tr (S78), and then the process is ended. On the other hand, if the controller 8 determines that Tr is not longer than T3 (S77: No), then the controller 8 sets the standby time T5 to T3 (S79), and then the process is ended.

According to the above modified example, if the first feed tray 91 is in the highest priority order and is the earliest one of the designated trays whose removal and reinstallation are detected after the interruption, then the image recording is restarted with the paper fed from the first feed tray 91. If the second feed tray 92 and the third feed tray 93 are not installed when the paper is fed from the first feed tray 91, then a jam will arise. Hence, if the longer one of Tr and T2 (or Tr and T3) is set to the standby time T5, then it is possible to more reliably prevent the jam from arising.

Further, in the above embodiment, the explanation was made with the case where the image recording is restarted automatically by feeding the paper into the bypass tray 94 after an interruption of the image recording. However, the image recording may be restarted after feeding the paper into the bypass tray 94 by the user's instruction.

Further, the notification of prohibiting removal of any undesignated tray may be made through audio but not by display on the touch panel 28. Further, such kind of notification to the user may be omitted.

Further, in the above embodiment, the explanation was made with the case where the controller 8 determines in the step S17-1 of FIG. 3 that the second feed tray 92 or the third feed tray 93 is removed and determines in the step S17-2 that the removed tray is reinstalled; thereafter, the controller 8 determines in the step S20 whether or not the standby time T1 has elapsed. However, without being limited to that, after the controller 8 first determines in the step S17-1 that the second feed tray 92 or the third feed tray 93 is removed and then determines in the step S17-2 that the removed tray is reinstalled, the image recording may be restarted immediately without the determination of the step S20.

In addition, it is possible to apply the present disclosure to apparatuses including at least two removable trays one of which defines part of the conveyance path from the other tray to the recording unit 6. Further, it is also possible to apply the present disclosure to single-function printer devices, scanner devices, and the like.

What is claimed is:

1. An image forming apparatus comprising:
a casing;
a feeder unit including a plurality of trays having a first tray and a second tray, each of the trays being installable into and removable from the casing, each of the trays having a support surface configured to support a medium;
an image recording unit arranged in the casing and configured to record an image on the medium supplied from the feeder unit based on a recording command including designation of at least one tray among the plurality of trays;
a conveyance mechanism defining a conveyance path of the medium supported by each of the trays, such that a part of the conveyance path from the first tray to the image recording unit includes a portion defined by the second tray;
an installation/removal sensor configured to detect whether the trays are removed from the casing or installed in the casing; and
a controller configured to perform:
interrupting an image recording of the image recording unit in a case that the medium is not supported on the at least one tray designated by the recording command;
restarting the image recording of the image recording unit by feeding the medium from the second tray after a first predetermined time has elapsed since such a time when the installation/removal sensor detects that the second tray is removed or reinstalled earliest in the at least one tray designated by the recording command, after the image recording is interrupted; and
restarting the image recording of the image recording unit by feeding the medium from the first tray in a case that the installation/removal sensor detects that the first tray is removed or reinstalled earliest in the at least one tray designated by the recording command but does not detect that the second tray is removed within a second predetermined time being longer than the first predetermined time, after the image recording is interrupted.

2. The image forming apparatus according to claim 1, wherein in a case that the image recording is restarted, the controller sets the second predetermined time to be longer for the case where the first tray and the second tray are designated by the recording command than for the case where the first tray is designated by the recording command but the second tray is not designated by the recording command.

3. The image forming apparatus according to claim 1, further comprising a first medium sensor configured to detect whether the medium is on the support surface of the second tray,
wherein the controller is configured to perform:
determining whether the medium is supported on the support surface of the second tray based on a detection of the first medium sensor in a case that the installation/removal sensor detects that the first tray is removed or reinstalled earliest in the at least one tray designated by the recording command; and
in a case that the image recording is restarted, setting the second predetermined time to be shorter for the case where the controller determines that the medium is supported on the support surface of the second tray than for the case where the controller determines that the medium is not supported on the support surface of the second tray.

4. The image forming apparatus according to claim 3, wherein the controller is configured to perform:
determining whether a type of the medium supported on the support surface of the second tray is same as a type of the medium supported on the support surface of the first tray; and
in a case that the image recording is restarted, setting the second predetermined time to be shorter for the case where the controller determines that the medium is not supported on the support surface of the second tray and where the type of the medium supported on the support surface of the second tray is different from the type of the medium supported on the support surface of the first tray, than for the case where the controller determines that the type of the medium supported on the support surface of the second tray is same as the type of the medium supported on the support surface of the first tray.

5. The image forming apparatus according to claim 1,
wherein the feeder unit includes three or more of the trays,
wherein the part of the conveyance path from the first tray to the image recording unit includes a portion defined by the second tray and another portion defined by a third tray different from the first tray and the second tray among the three or more trays,
wherein another part of the conveyance path from the second tray to the image recording unit includes a portion defined by the third unit, and
wherein in a case of restarting the image recording, the controller is configured to perform:
causing the image recording unit restart the image recording by feeding the medium from the third tray after a third predetermined time that is shorter than the first predetermined time has elapsed since such a time when the installation/removal sensor detects that the third tray is removed or reinstalled earliest in the at least one tray designated by the recording command, after the image recording is interrupted;
causing the image recording unit to restart the image recording by feeding the medium from the second tray in a case that the installation/removal sensor detects that the second tray is removed or reinstalled earliest in the at least one tray designated by the recording command but does not detect that the third tray is removed within the first predetermined time, after the image recording is interrupted; and
causing the image recording unit to restart the image recording by feeding the medium from the first tray in a case that the installation/removal sensor detects that the first tray is removed or reinstalled earliest in the at least one tray designated by the recording command but does not detect that the second tray or the third tray is removed within the second predetermined time, after the image recording is interrupted.

6. The image forming apparatus according to claim 5, further comprising a memory configured to store a priority order, for the three or more trays, of feeding the medium to the image recording unit.

7. The image forming apparatus according to claim 6, wherein the memory stores a higher priority order for the first tray than for the second tray; and for restarting the image recording, the controller causes the image recording unit to restart the image recording by feeding the medium from the first tray after such a time has elapsed as the longer one out of the comparison between the first predetermined time, and the remaining time of the second predetermined time at the point of time when the installation/removal sensor detects that the first tray is the earliest one being removed and reinstalled in one or more of the trays designated by the recording command, and that the second tray is removed and reinstalled within the second predetermined time, after the image recording is interrupted.

8. The image forming apparatus according to claim 1,
wherein the feeder unit further includes a back feeder tray that is fixed on a back of the casing and that has a support surface configured to support the recording medium,
wherein the image forming apparatus further comprises a second medium sensor configured to detect whether the recording medium is supported on the support surface of the back feeder tray, and
wherein in a case of restarting the image recording, the controller causes the image recording unit to restart the image recording by feeding the medium from the back feeder tray after a fourth predetermined time that is longer than the first predetermined time has elapsed, in a case that the second medium sensor detects that, after being absent of the medium on the support surface of the back feeder tray, the recording medium is supported on the support surface of the back feeder tray, after the image recording is interrupted.

9. The image forming apparatus according to claim 1, further comprising an alarm unit configured to notify a user of information,
wherein in a case that the first tray is designated by the recording command but the second tray is not designated by the recording command, the controller controls the alarm unit to notify the user that the second tray should not be removed from the casing after the image recording is interrupted.
